(19) United States
(12) Patent Application Publication
(10) Pub. No.: US 2002/0037405 A1
(43) Pub. Date: Mar. 28, 2002

(54) Aluminum faced self adhering membrane

(75) Inventors: Michael P. Naipawer III, Bloomingdale, NJ (US); Adem Chich, Kearny, NJ (US); Murray S. Sherman, Leland, NC (US)

Correspondence Address: GAF MATERIALS CORPORATION, Att: William J. Davis, Esq., Legal Department, Building No. 10, 1361 Alps Road, Wayne, NJ, 07470, US

(73) Assignee: BUILDING MATERIALS INVESTMENT CORPORATION

(21) Appl. No.: 09/922,456

(22) Filed: Aug. 3, 2001

Related U.S. Application Data
(60) Provisional application No. 60/235,644, filed on Sep. 26, 2000.

(51) Int. Cl. B32B 7/12; B32B 13/02

(52) U.S. Cl. 428/351; 428/343; 428/352; 428/354

(57) ABSTRACT

A self-adhering, multi-layer composite membrane for sealing a substrate and providing waterproof integrity to the substrate. The composite membrane includes: a surface layer of metal or of a polymeric material to interface the environment; a polyolefin film having a top surface and a bottom surface bonded to the surface layer by an adhesive at its top surface; a waterproof, asphalt-based layer adhered to the polyolefin film; a reinforcing mat having a top surface and a bottom surface, the top surface of which is adhered to the waterproof, asphalt-based layer; a second waterproof, asphalt-based layer adhered to the bottom surface of the reinforcing mat which is adapted to sealingly adhere to the substrate; and a polyolefin release film on the bottom surface of the waterproof asphalt-based adhesive layer to prevent adhesion between the asphalt-based adhesive layer and the surface layer when the composite is wound into a spiral roll.

### CROSS-REFERENCE TO RELATED PATENT APPLICATION

This application is based on Provisional Application Serial No. 60/235,644, filed Sep. 26, 2000.

### BACKGROUND OF THE INVENTION

1. Field of the Invention

This invention relates to a waterproofing, self-adhering multi-layer composite membrane for sealing substrate structures and preventing degradation thereof by ultraviolet rays from the sun. More particularly, the invention relates to a self-adhering multi-layer composite membrane suitable for use as a single roofing without being overlaid by roof shingles.

2. Reported Developments

The prior art uses bituminous roofing membranes and synthetic roofing sheets for waterproofing roof structures in the building construction industry. The roofing membranes or sheets comprise a laminated composite of two or more layers. Illustrative examples are: U.S. Pat. No. 3,581,779 which discloses a two-layer laminate; U.S. Pat. Nos. 4,457,983 and 4,911,975 which disclose a three-layer laminate; and U.S. Pat. Nos. 4,636,414, 4,936,938 and 5,096,759 which disclose a five-layer laminate. The 4,636,414 and the 5,096,759 patents have laminates comprising:

an uppermost aluminum foil which is exposed to sunlight and the environment and is intended to protect the underlying layers;

a polyethylene sheet;

an ionomer resin adhesive bonding together the aluminum foil and the polyethylene sheet;

a thick coating of bitumen bonded to the other surface of the polyethylene sheet intended to adhere to the roof deck; and

a release paper applied to the exposed bitumen surface so that when the laminate is wound into a spiral roll the release paper prevents adherence of the bitumen layer to the aluminum foil.

The collective objects of the inventions disclosed by the above-mentioned patents include the provision in a laminate for use in the building industry: waterproofing, protection against ultraviolet rays of the sun; easy handling; and dimensional stability.

While some of these objects have been adequately met, further improvements are desirable to provide for the needs of the building industry. A general object of the present invention is to provide such improvements.

### SUMMARY OF THE INVENTION

In accordance with the present invention a self-adhering multi-layer composite membrane is provided for sealing a substrate. The function of the membrane is to secure waterproof integrity to the substrate to which it is adhered; one substrate being a roofing deck, and the other substrate being roofing portions or roofing details of existing substrates that need repair, such as valleys or hips where the membrane functions as a repair tape. As a repair tape, the application of the membrane includes application to masonry, aluminum, copper and steel roofing, and gutters made of metals or plastics. The invention provides wound rolls of the membrane in appropriate sizes suitable for each kind of application.

The membrane is a multi-layer composite comprising seven layers.

The first layer or surface foil is preferably an aluminum foil having a thickness of 0.5 to 3 mils, and preferably about 1.0 mil. The aluminum foil provides a surface with high reflective properties against sun rays. Alternative surface foils include copper foil, polyethylene and polypropylene films having a thickness of 0.5 to 3 mils or more.

The second layer of the membrane comprises a suitable adhesive that bonds with both the surface foil and a polyolefin film, such as polyethylene and polypropylene, or a polyester film. The adhesive may be of several kinds and include a urethane and an ionomer resin such as sold by the DuPont company under the trademark SURLYN.

The third layer is a polyolefin film and preferably a high density polyethylene film commonly known by its tradename VALERON. The polyolefin film has a thickness of from about 0.5 to about 5 mils, and preferably about 1-3 mils.

The fourth layer is a waterproof asphalt-based adhesive layer modified with a styrene-butadiene-styrene polymer (SBS). This layer also contains a limestone filler in finely divided form.

The fifth layer of the multi-layer composite membrane is a non-woven fiberglass mat substrate which is a reinforcing mat to provide strength to the membrane. The layer has a weight of from about 20 to about 120 g/m², and preferably of from about 75 to about 100 g/m². Alterative substrates include polyester mats, organic papers and hybrids thereof.

The sixth layer of the multi-layer composite membrane is the same as the fourth layer described above.

The seventh layer is a release film to prevent adhesion of the waterproof sixth adhesive layer and the first surface aluminum foil of the multi-layer composite membrane when the membrane is wound into a spiral roll during the manufacturing process. This layer includes polyolefin films, such as polyethylene and polypropylene films in a thickness of from about 0.5 to about 5.0 mils, and preferably of from about 1.0 mil to about 3 mils. The film is treated on the inner surface thereof with silicone to facilitate its release from the aluminum foil when the membrane is being installed on a substrate such as a roof deck.

The multi-layer composite membrane of the present invention has improved physical properties including tensile strength, tear strength, impact resistance and resistance against deterioration caused by ultraviolet rays of the sun.

### BRIEF DESCRIPTION OF THE DRAWINGS

FIG. 1 is a perspective view of the waterproofing, self-adhering multi-layer composite membrane of the present invention; and

FIG. 2 is a sectional view taken along the line 2-2 of FIG. 1; and

FIG. 3 is a diagrammatic view showing the manufacturing process.

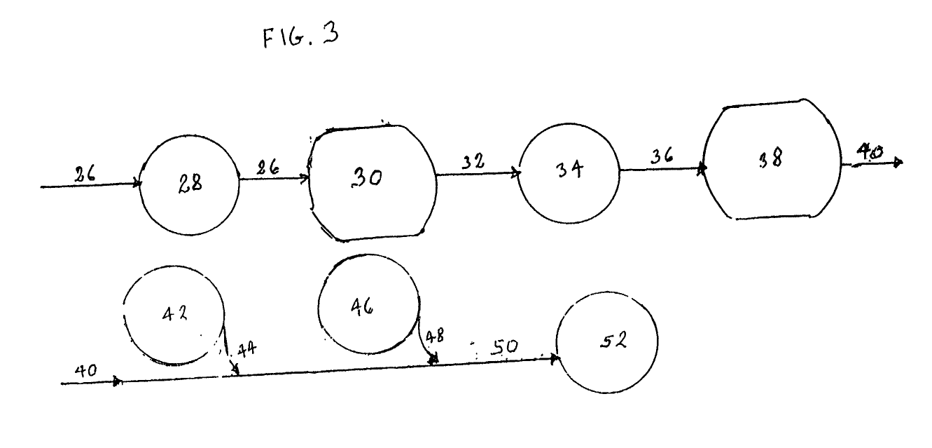

### DETAILED DESCRIPTION OF THE INVENTION

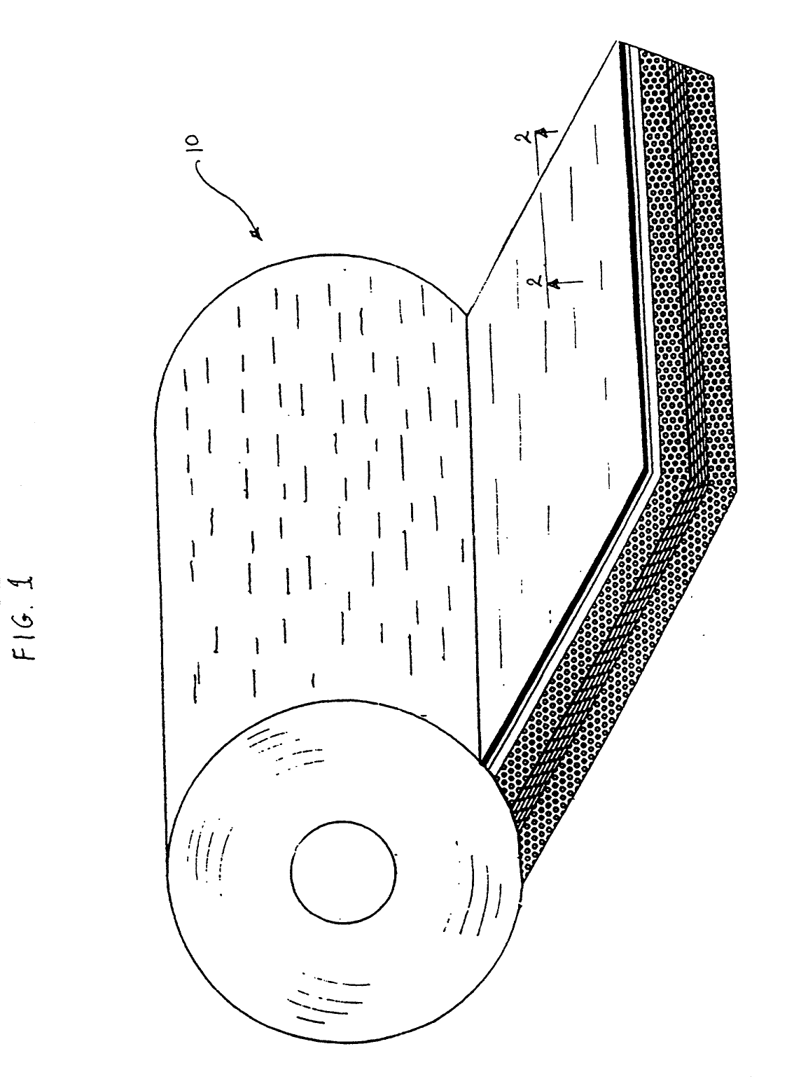

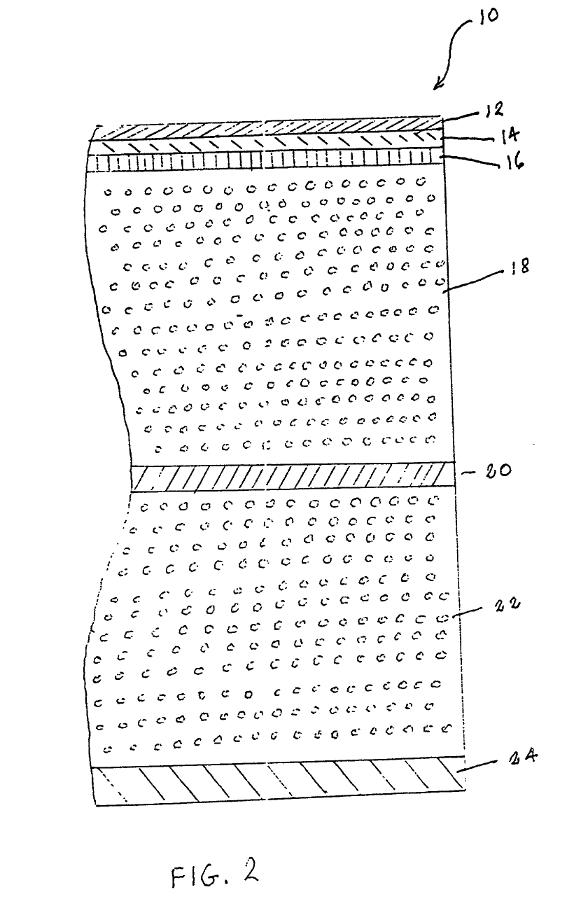

Referring to FIGS. 1 and 2, the waterproofing, self-adhering multi-layer composite membrane is generally designated by the numeral 10. FIG. 1 shows a perspective view of the membrane in a wound spiral roll form; and FIG. 2 shows a sectional view of the membrane taken along the line 2-2 of FIG. 1. The composite membrane comprises seven layers of materials adhesively united to each other.

The first layer 12 of membrane 10 is a surfacing layer adapted to face the outside environment when the composite membrane 10 is installed on a substrate, such as the deck of a roof. The first layer is preferably an aluminum film foil with a weatherable surface with high albedo properties.

The second layer 14 of membrane 10 is an adhesive layer capable of bonding the first layer 12 to the third layer designated by the numeral 16 which comprises a polyolefin film, and preferably a high density polyethylene film. This layer is designed to enhance the physical properties of the membrane.

The fourth layer 18 is a waterproof asphalt based adhesive modified with a styrene-butadiene-styrene polymer (SBS) (topcoat) containing a limestone filler in a finely divided form. The formulation contains: of from about 60% w/w to about 80% w/w of asphalt flux; of from about 5% w/w to about 15% w/w of SBS polymer or styrene-iso-styrene (SIS) polymer which can be obtained under the tradename KRATON from Shell Chemical; of from about 5% w/w to about 30% w/w of a limestone filler; and from about 0.1% w/w to about 10% w/w naphthennic oil which can be obtained under the tradename SHELLFLEX from Equilon. Tackifiers and plasticizers, such as polybutene polymers, such as INDOPOL sold by BP Amoco, and hydrocarbon resins may also be included in the formulation. The waterproof asphalt based adhesive layer coats both surfaces of the substrate, which is the fifth layer 20 of the multi-layer composite membrane. The thickness of the fourth layer is from about 0.5 mils to about 30 mils, and preferably of from about 5 mils to 20 mils. Alternatively, other adhesives may be used comprising butyl rubber, APP, TPO and PIB formulations.

The fifth layer 20 of the multi-layer composite membrane is a fiberglass or substrate mat to provide strength and reinforcement to the membrane, and to accept the hot, molten asphalt composition on both sides thereof. A typical embodiment of the polyester polyethylene terpthalate (PET).

Adhered to the fifth layer 20 (backcoat) of multi-layer composite 10 is a waterproof asphalt based adhesive layer 22 modified with a styrene-butadiene-styrene polymer (SBS). The composition of this layer and its parameters are the same as that of the fourth layer.

The seventh layer 24 is a release film to prevent adhesion of the waterproof asphalt based sixth layer to the first layer 12 of the multi-layer, self-adhering membrane during the process of winding the membrane into a spiral roll and, subsequently to provide for easy unrolling during installation of the same on a substrate.

Reference is now made to the process of making the aluminum faced, self-adhering membrane of the present invention.

(A) Preparation of the waterproof adhesive compound used in layer 4 and layer 5

Asphalt flux is heated in a vat to about 380° F., styrene-butadienestyrene (SBS) polymer is added to the heated asphalt flux, and the two components are mixed using a Siefer type mixer. Mixing is continued for about 30 to 60 minutes in order to obtain a homogenous mixture. The SBS polymer swells at this temperature and an emulsion is formed in which the asphalt is encapsulated in the SBS polymer matrix. The encapsulation greatly improves such desirable properties as cold flex, elongation, elastic modules, temperature stability and softening point.

After encapsulation of the asphalt, naphthennic oils and/or additional plasticizers and/or tackifiers are added and mixed into the encapsulated mixture. After additional paddle mixing to disperse the oil, a limestone filler is added and mixed into the encapsulated mixture. The limestone filler is used to extend the waterproof adhesive compound and thereby make the product less costly. Subsequent to the addition of the limestone filler the compound is transferred to an impregnator vat.

(B) Preparation of the aluminum foil/plastic film composite

High density polyethylene (HDPE) film is placed on an unwind stand and threaded through a Gravure embossing roll. The film is then coated on both sides with a solvent based, two-part urethane adhesive. The coated film enters into a drying station to dry off the solvent in the adhesive. This drying step cures the adhesive before the aluminum foil is applied.

The aluminum foil under heat and pressure is then bonded to the urethane adhesive-coated film in a laminator thereby obtaining the HDPE/aluminum foil layers which are to be used in the manufacture of the finished product.

Manufacturing the finished product

A fiberglass mat or a polyester substrate 26 on a roll 28 is placed on an unwind stand. The substrate 26 is drawn through the impregnator vat 30 which contains the waterproof adhesive compound prepared in (A) at a temperature of 300°-380° F. The waterproof adhesive compound (A) coats the substrate 26 on both sides thereof thereby producing a waterproof adhesive/substrate/waterproof adhesive laminate 32. This laminate is passed through two caliper rolls 34 that meters the thickness of the laminate. The metered laminate 36 is floated across a water bath 38 to cool the laminate and to form a metered and cooled laminate 40. Exiting the water bath, the aluminum foil 44 (surface layer) from a roller 42 is laminated to the metered and cooled laminate 40 using pressure and the residual heat remaining in the metered and cooled laminate 40. A release film, such as silicone treated high density polyethylene (HDPE) film 48 is then applied to the back of the metered and cooled laminate 40 using a large turn over drum 46 to product the finished product 50. Finally, the finished product is rolled up into a spiral roll 52 for on-site use or slit into smaller width rolls. The roll product optionally can be provided with a release film along one edge. The release film can be a polyethylene film and is sometimes referred to in the art as a release selvage edge. The release film facilitates bonding between layers during installation.

One application of the waterproof, self-adhering composite membrane of the present invention includes installation of full width rolls which are approximately 36″ by 50′ to a roofing deck in overlapping stepwise manner so that there is continuous full coverage of the roof. The underlying deck can be any of a number or typical roof deck substrates that are not waterproofed. Common roof deck materials include plywood sheeting, tongue and groove wood sheeting, oriented strand board (OSB), and isocyanorate foam insulation board.

Another application involves the use of smaller segments of the membrane as a waterproof flashing for roofing details, or as a repair tape for waterproofed substrates that, for reason of deterioration by the environment, are leaking. Examples of waterproof flashing details include valleys, lips, and sealing around protruding objects of the roof structure, such as vents and air conditioning units. The membrane is also well suited for application on masonry, aluminum, copper and steel roofing, existing commercial roofs, and gutter stocks made of metals or plastics. The width of these tapes are typically 1″ to 24″ with lengths of 50′ which are then cut to the desired size.

Having described the invention with reference to its preferred embodiments, it is to be understood that modifications within the scope of the invention will be apparent to those skilled in the art.

What is claimed is:

1. A self-adhering, multi-layer composite membrane for sealing a substrate and providing waterproof integrity thereto comprising:
a surface layer adapted to interface the environment;
an adhesive layer, having a top surface and a bottom surface, said top surface forming a bond with said surface layer;
a polyolefin film adhered to said bottom surface of said adhesive layer forming a bond therewith;
a waterproof, asphalt-based adhesive layer adhered to said polyolefin film;
a reinforcing mat, having a top surface and a bottom surface, said top surface adhered to said waterproof, asphalt-based adhesive layer;
a waterproof, asphalt-based adhesive layer, having a top surface and a bottom surface, said top surface adhered to said bottom surface of said reinforcing mat, and said bottom surface is adapted to sealingly adhere to a substrate; and
a polyolefin release film on the bottom surface of said waterproof asphalt based adhesive layer to prevent adhesion of said waterproof asphalt based adhesive layer and said surface layer when said multi-layer composite membrane is wound into a spiral roll.

2. The self-adhering, multi-layer composite membrane of claim 1, wherein said surface layer is a metal or a polymeric material having a thickness of from about 0.5 mils to about 3.0 mils.

3. The self-adhering, multi-layer composite membrane of claim 2 wherein said metal is aluminum or copper.

4. The self-adhering, multi-layer composite membrane of claim 2 wherein said polymeric material is polyolefin.

5. The self-adhering, multi-layer composite membrane of claim 4 wherein said polyolefin is polyethylene or polypropylene.

6. The self-adhering, multi-layer composite membrane of claim 5 wherein said polyethylene is a high density polyethylene.

7. The self-adhering, multi-layer composite membrane of claim of claim 1 wherein said waterproof asphalt based adhesive layer contains a styrene-butadiene-styrene polymer.

8. The self-adhering, multi-layer composite membrane of claim 7 wherein said waterproof asphalt based adhesive layer further comprises a limestone filler in finely divided form.

9. The self-adhering, multi-layer composite membrane of claim 1 wherein said reinforcing mat is selected from the group consisting of polyester, fibergalss and organic papers having a weight of from about 20 g/m² to about 120 g/m².

10. The self-adhering, multi-layer composite membrane of claim 9 wherein said reinforcing mat is polyethylene terphthalate.

11. The self-adhering, multi-layer composite membrane of claim 1 wherein said polyolefin release film has a thickness of from about 0.5 mils to about 5.0 mils.

12. The self-adhering, multi-layer composite membrane of claim 1 wherein said polyolefin release film is treated with silicone to facilitate release from the surface layer when the self-adhering multi-layer composite membrane is wound into a spiral roll or when said self-adhering multi-layer composite membrane is installed on a substrate.

13. The self-adhering multi-layer composite membrane of claim 1 wherein said waterproof asphalt-based adhesive layer comprises:
of from about 60% w/w to about 80% w/w of asphalt flux;
of from about 5% w/w to about 15% w/w of styrene-butadiene-styrene polymer or styrene-iso-styrene polymer;
of from about 5% w/w to about 30% w/w of a limestone filler; and
of from about 0.1% w/w to about 10% w/w naphthennic oil.

14. The self-adhering, multi-layer composite membrane of claim 13 wherein the thickness of said waterproof asphalt based adhesive is of from about 0.5 mils to about 30 mils.

15. The self-adhering, multi-layer composite membrane of claim 13 wherein said waterproof asphalt-based adhesive layer further comprises from about 0.1% w/w to about 10% w/w of a polybutene polymer.
